(19) United States
(12) Patent Application Publication
(10) Pub. No.: US 2024/0125303 A1
(43) Pub. Date: Apr. 18, 2024

(54) WIND TURBINE ROTOR BLADE AND WIND TURBINE

(71) Applicant: Wobben Properties GmbH, Aurich (DE)

(72) Inventors: Hussam Daboul, Südbrookmerland (DE); Muhanad Mahmoud, Aurich (DE)

(21) Appl. No.: 18/476,947

(22) Filed: Sep. 28, 2023

(30) Foreign Application Priority Data
Oct. 17, 2022 (EP) 22201961.4

(51) Int. Cl. F03D 80/60; F03D 1/06

(52) U.S. Cl. CPC F03D 80/602; F03D 1/06; F03D 1/0675

(57) ABSTRACT

The invention relates to a wind turbine rotor blade with a length, a rotor blade root, a rotor blade tip, a pressure side, a suction side, a leading edge, a trailing edge and an air guide for heated air for guiding heated air inside of the rotor blade and along a longitudinal direction of the rotor blade from the rotor blade root in the direction of the rotor blade tip. The wind turbine rotor blade also comprises at least two air guide sections and at least one heat exchanger for conveying heat from one air guide section to another air guide section.

### BACKGROUND

### Technical Field

The present invention relates to a wind turbine rotor blade and a wind turbine.

### Description of the Related Art

Since rotor blades are exposed to all weather conditions unprotected, the rotor blades can become iced at specific temperatures. A rotor blade heater can be used to prevent this. Either a heater can be provided outside on the rotor blade, or heated air can be made available inside of the rotor blade. For example, this can take place by means of a heating register, which generates hot air that is then blown into the interior of the rotor blade.

WO 2017/021350 A1 shows a wind turbine rotor blade with a rotor blade root area and a rotor blade tip area, as well as a rotor blade heater. At least one web is further provided along a longitudinal axis of the rotor blade. A deflection unit in the form of a bar drop can be provided on the web, so as to reduce air turbulence in the deflection process.

WO 2018/211055 shows a wind turbine rotor blade with a rotor blade heater. The rotor blade has a web and a deflection unit in the area of the rotor blade tip for deflecting heated air.

### BRIEF SUMMARY

The present disclosure is directed to a wind turbine rotor blade that enables an improved heating of the rotor blade.

In at least one embodiment, provided is a wind turbine rotor blade with a rotor blade root, a rotor blade tip, a pressure side and a suction side, a leading edge, and a trailing edge. The rotor blade has a longitudinal direction. A rotor blade heater is used to generate hot air, which is then blown into the interior of the rotor blade. An air guide is provided inside of the rotor blade. The air guide can have at least two air guide sections, e.g., in the form of air channels, which are at least partially separated from each other in design. At least one heat exchanger with a first and a second end is provided. The first end of the heat exchanger reaches into a first air guide section, while the second end of the heat exchanger protrudes into a second air guide section. The heat exchanger is used to convey heat from one of the air guide sections into the other air guide section.

The heat exchanger can be a passive heat exchanger, which is capable of conveying the heat without any energy being supplied from outside.

The heat exchanger can be configured as a heat pipe (heat pipe), as a two-phase thermosyphon or as a heat bridge.

At least one web or some other attachment part of the rotor blade can be provided between the pressure side and the suction side along the longitudinal direction of the rotor blade. The air heated by the rotor blade heater can be blown along the web in the direction of the rotor blade tip through an air guide section, where it is deflected, so that the heated air on the other side of the web can flow back from the rotor blade tip area to the rotor blade root area through another air guide section. At least one heat exchanger can be arranged in or on the web or the attachment part in such a way that a first end of the heat exchanger protrudes into an air guide section and a second end of the heat exchanger protrudes into an air guide section on the other side of the web. As a result, heat can be conveyed from the warmer end to the colder end of the heat exchanger.

Hot air in one of the air guide sections flows past the first or second end of the heat exchanger, and heats the first or second end. The heat in the first or second end is conveyed to the second or first end via the heat exchanger (which is configured as a passive heat exchanger). The air in the other air guide section that flows by the second or first end of the heat exchanger then absorbs the heat in the second or first end. As a result, the second or first end is cooled. Since heat comes from the first or second end of the heat exchanger again, the second or first end is heated once more, and can again emit this heat back into the air flowing by.

The heat exchanger can be provided with a web between a first and a second air guide section, and be coupled on its one side to the rotor blade inner wall or to a web, so that heat is conveyed transversely to the web.

A rotor blade heating system that can comprise an air heating system is provided to improve a temperature distribution on the exterior of a rotor blade, in particular at low ambient temperatures or given an ice accretion. The interior of the rotor blade can be provided with (several) air guide sections, such as air channels. Hot air from the rotor blade heater is blown into one of the air guide sections. The air can here have a temperature of 70° C. The heated air is guided along the first air guide section from rotor blade root to the rotor blade tip. The at least already partially cooled air can subsequently be deflected back in the direction of the rotor blade root again via a second air guide section. At least one heat exchanger is provided to improve the heat distribution in particular on the wall of the rotor blade, and allows heat to be conveyed from one air guide section to another air guide section. This preferably takes place without any mass transfer. Heat can also be conveyed via heat bridges.

The rotor blade can have at least one bypass in the web, so as to allow air to flow from one air guide section through the web to another air guide section.

The heat exchanger as a passive heat exchanger can be configured as a heat pipe (heat pipe) or as a heat bridge, for example in the form of heat conductive materials. For example, such materials can be copper or aluminum. The heat exchangers have a first and second end, wherein one end protrudes into the first air guide section, and the second end protrudes into the second air guide section.

The advantage to heat exchangers is that they have only a small cross sectional surface, and that providing such a heat exchanger in a web of a rotor blade leads to only a slight reduction in the mechanical stability of the web. By contrast, the mechanical stability of the web might become impaired in the case of bypasses, since several holes must be present in the web to be able to realize a bypass.

As a consequence, a heat exchanger with a low cross sectional surface is provided.

Providing the heat exchangers inside of the rotor blade makes it possible to significantly improve the efficiency of the rotor blade heater. In particular, a local influence on heat distribution can be improved.

According to an aspect of the present disclosure, at least one bypass can also be provided in or on the web in addition to the heat exchangers.

The heat exchanger can optionally have a surface enlargement (for example, in the form of a ribbed structure). The surface enlargement can be provided on the first and/or second end. Heat transfer can be improved with the surface enlargement.

The heat exchanger can be configured as a passive heat transport unit for transporting heat from one end to the other end.

Additional embodiments of the invention are the subject of the subclaims.

### BRIEF DESCRIPTION OF THE SEVERAL VIEWS OF THE DRAWINGS

Advantages and exemplary embodiments of the invention will be described in more detail below with reference to the drawing.

FIG. 1 shows a schematic view of a wind turbine according to the invention,

FIG. 2 shows a schematic, sectional view of the rotor blade of the wind turbine on FIG. 1 according to a first exemplary embodiment,

FIG. 3 shows a schematic, sectional view of the rotor blade of the wind turbine on FIG. 1 according to a second exemplary embodiment.

### DETAILED DESCRIPTION

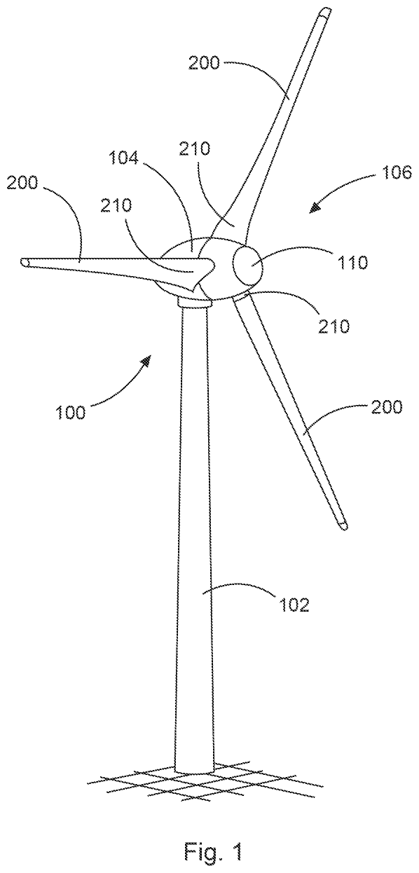

FIG. 1 shows a schematic view of a wind turbine according to the invention. The wind turbine 100 has a tower 102 and a nacelle 104 on the tower 102. An aerodynamic rotor 106 with three rotor blades 200 and a spinner 110 is provided on the nacelle 104. During operation of the wind turbine, the aerodynamic rotor 106 is made to rotate by the wind, and thereby also turns a rotor or runner of a generator, which is directly or indirectly coupled with the aerodynamic rotor 106. The electric generator is arranged in the nacelle, and generates electric energy. The pitch angles of the rotor blades 200 can be changed by pitch motors on the rotor blade roots 210 of the respective rotor blades 200.

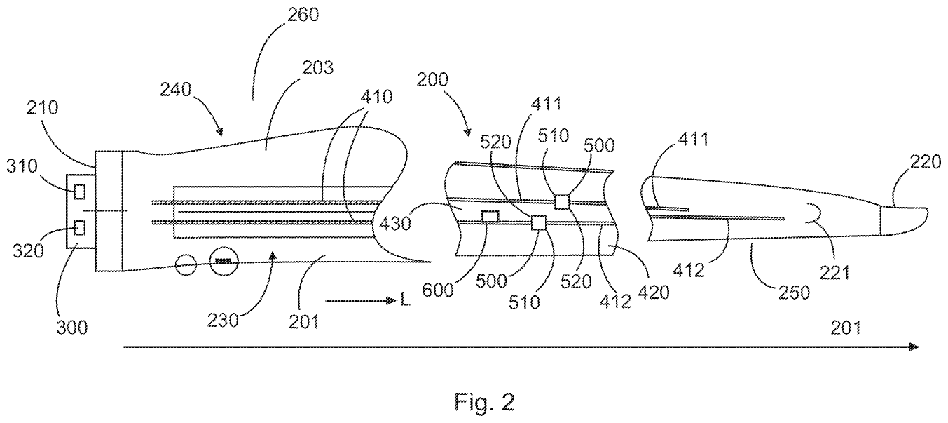

FIG. 2 shows a schematic, sectional view of the rotor blade of the wind turbine on FIG. 1 according to a first exemplary embodiment. The rotor blade 200 has a length 201, a rotor blade root 210, a rotor blade tip 220, a leading edge 230, a trailing edge 240, a pressure side 250, and a suction side 260. Provided inside of the rotor blade 200 is an air guide 400, for example which can be designed like a first, second and/or third air guide section 420, 430, 440. The air guide sections 420, 430, 440 can be separated from each other at least partially along the length 201 of the rotor blade 200 by elements of the rotor blade (e.g., webs 410). A rotor blade heater 300 can be provided in the area of the rotor blade root 210. The rotor blade heater 300 can have a fan 320 and a heating unit 310, and generate hot air that can be guided into the interior 203 of the rotor blade 200.

The rotor blade heater 300 can be integrated into the rotor blade, or be provided outside of the rotor blade.

At least one web 410, 411, 412 extends along a longitudinal direction L of the rotor blade 200 inside of the rotor blade, and is part of the air guide 400 or already present for other reasons, with the air guide 400 having only a secondary function. More than one web can optionally be provided. The webs 411, 412 can at least partially separate the first, second and/or third air guide sections 420, 430, 440 from each other.

The air heated by the rotor blade heater 300 can be guided in the third air guide section 440 along the web 411 as part of the air guide 400 in the direction of the rotor blade tip 220, and then be deflected in the area of the rotor blade tip 220. The heated air can then be guided along the first or second air guide section 420, 430 to the rotor blade root. To this end, a deflection section 202 can be present in the area of the rotor blade tip 220. The rotor blade tip 220 can optionally be at least partially hollow in design, so that a portion of the heated air can flow through the rotor blade tip 220, in order to also deice the rotor blade tip 220.

The heated air can be generated by means of the rotor blade heater 300 either in the rotor blade root area, by virtue of a heating unit 210 heating the air, or the heated air is supplied to the rotor blade 200 in the area of the rotor blade root 210.

At least one aerodynamic mixer 500 can be provided along the length L of the rotor blade 200 in the air guide 400. The heat exchanger 500 has a first and second end 510, 520. The first and second ends 510, 520 of the heat exchanger 500 are provided in different air guide sections 420, 430 440, and can thus convey heat from one air guide section into another air guide section. This is advantageous, since it can lead to an improved mixing of the air flow.

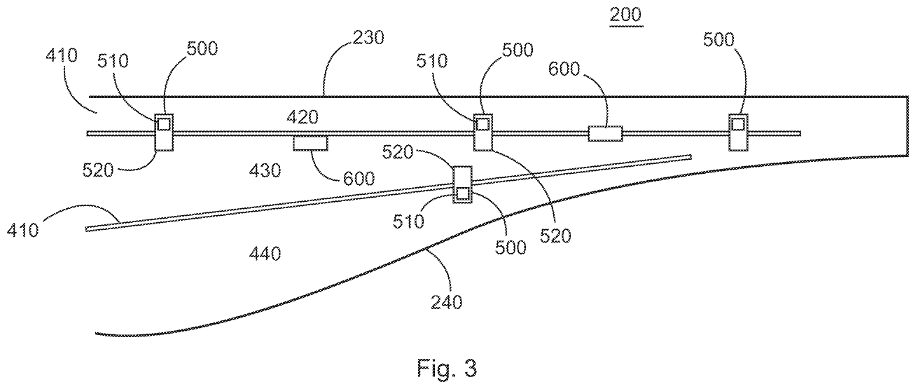

FIG. 3 shows a schematic view of a rotor blade according to a second exemplary embodiment. The rotor blade 200 has a rotor blade root 210, a rotor blade tip 220, a leading edge 230, and a trailing edge 240. Provided inside of the rotor blade is at least one web 410, which extends from the area of the rotor blade root 210 into the area of the rotor blade tip 220. The rotor blade 200 has at least one heat exchanger 500 with a first and second end 510, 520.

The heat exchanger 500 can be configured as a heat pipe (heat pipe) or as a rod comprised of a thermally conductive material (for example, copper or aluminum). The heat exchanger 500 is characterized in that it has a small cross sectional surface, and requires no opening in the web. The heat exchanger 500 can already be integrated during the manufacture of the web 410. Alternatively thereto, a borehole or opening can be provided in the web 410, and the heat exchanger 500 can be inserted with the web later on, after manufacturing the web and, for example, after manufacturing the rotor blade.

The heat exchanger 500 has a first and second end 510, 520. A first end 510 extends into a first air guide section, and a second end 520 extends into another air guide section separated from the air guide section with the first end by a web 410 or another attachment part. The heat exchanger 500 is used to convey heat from its one end to its other end. Heated warm air here flows through the rotor blade heater 300 and past the first or second end 510, 520 of the heat exchanger 500, and heats the heat exchanger 500. The heat then spreads to the other (second or first) end 520, 510, and heats the second or first end 520, 510 accordingly. Air that passes by the second (or first) end 520, 510 can absorb heat from the second end 520. The second end 520 of the heat exchanger 500 thus leads to a heating of the air passing through the other air guide section.

Air heated by the rotor heater 300 flows along a first air guide section from the rotor blade root to the rotor blade tip, is there deflected, and then flows in another (second) air guide section back in the direction of the rotor blade. In the first air guide section, the air heats the outer wall of the rotor blade, at least in those areas where air flows by an outer wall of the rotor blade. This leads to a cooling of the heated air. In other words, air arriving in the area of the rotor blade tip will thus be colder than the air directly heated by the rotor blade heater. The air that flows from the rotor blade tip along the first air guide section to the rotor blade tip continuously decreases in temperature, and hence warms the wall of the rotor blade. The air that then passes from the rotor blade tip through another air guide section in the direction of the rotor blade root has a low temperature. In order to raise the temperature in the other air guide section, the heat exchanger can be provided in or on the web in such a way that its first end protrudes into a first air guide section, and its second end protrudes into the second air guide section. The air heated by the rotor blade heater flows by the first end, and heats the first end. The heat in the first end then spreads in the direction of the second end. As a consequence, the air flowing back along the other air flow section can be further heated at least locally by the heat exchanger. This makes it possible to achieve a more uniform temperature distribution between the air guide sections.

A heat exchanger can be used in a targeted manner at specific positions, so as to reduce a local temperature increase in an area. A heat exchanger can further be provided to compensate for a local temperature reduction.

The heat exchanger can be configured as a heat pipe or heat pipe, as a 2-phase thermosyphon or as a heat bridge. For example, a heat bridge can be a rod comprised of a thermally conductive material (for example, copper or aluminum). In addition, other nonmetallic, thermally conductive materials are possible. This is advantageous, since it makes sense given the lighting protection issue to not use metal in the rotor blade, if at all possible.

In addition to the heat exchangers 500, at least one bypass 600 can be provided in or on one of the webs.

The solution according to the invention can be used in particular for rotor blades of a wind turbine that have a large length and a lower inner cross section.

### REFERENCE LIST

100 Wind turbine
102 Tower
104 Nacelle
106 Rotor
110 Spinner
200 Rotor blades
201 Length
202 Wall
203 Interior of rotor blade
210 Rotor blade root
220 Rotor blade tip
221 Deflection section
230 Leading edge
240 Trailing edge
250 Pressure side
260 Suction side
300 Rotor blade heater
310 Heater
320 Fan
400 Air guide
410 Web
411 Web
412 Web
420 First air guide section
430 Second air guide section
440 Third air guide section
500 Heat exchanger
510 First end
520 Second end
600 Bypass
L Longitudinal direction

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind turbine rotor blade, comprising:
a rotor blade body having a length, a rotor blade root, a rotor blade tip, a pressure side, a suction side,
an air guide for heated air to guide heated air inside of the rotor blade body and at least partially along a longitudinal direction of the rotor blade body from the rotor blade root to the rotor blade tip, and
wherein the air guide has at least one first and second air guide sections separated from each other,
at least one heat exchanger inside of the rotor blade body and having a first end and a second end,
wherein the first end of the heat exchanger protrudes into the first air guide section, and the second end protrudes into the second air guide section, wherein the at least one heat exchanger is a passive heat exchanger that is configured to convey heat from one of the first and second air guide sections to another one of the first and second air guide sections without energy being supplied from outside the rotor blade body.

2. The wind turbine rotor blade according to claim 1, wherein the air guide has at least one web, which is arranged at least partially between the pressure side and the suction side, and extends at least partially along the longitudinal direction of the rotor blade body and separates at least two air guide sections from each other,
wherein at least one heat exchanger is arranged in or on the at least one web.

3. The wind turbine rotor blade according to claim 2, wherein the at least one heat exchanger is arranged perpendicular to the at least one web.

4. The wind turbine rotor blade according to claim 1, further comprising:
at least one bypass in a web for coupling the first air guide section with the second air guide section,
wherein the at least one bypass is configured to allow air to flow from one air guide section of the first and second air guide sections through the bypass in the web to another air guide section of the first and second air guide sections.

5. The wind turbine rotor blade according to claim 1, wherein the heat exchanger is a heat pipe or a two-phase thermosyphon.

6. The wind turbine rotor blade according to claim 1, wherein the heat exchanger is made out of a thermally conductive material.

7. The wind turbine rotor blade according to claim 6, wherein the thermally conductive material is a metal material.

8. The wind turbine rotor blade according to claim 1, further comprising a rotor blade heater at the rotor blade root, wherein the rotor blade heater is configured to guide heated air into an interior of the rotor blade body.

9. A wind turbine, comprising at least one wind turbine rotor blade according to claim 1.
